(19) United States
(12) Patent Application Publication
(10) Pub. No.: US 2015/0099068 A1
(43) Pub. Date: Apr. 9, 2015

(54) STEEL CORD FOR EXTRUSION PROCESS, AN APPARATUS AND METHOD AND USE OF SAID STEEL CORD

(71) Applicant: NV BEKAERT SA, Zwevegen (BE)

(72) Inventors: Zhichao Cheng, Jiangsu (CN); Pengfei Wang, Jiangsu (CN); Linglong Yang, Jiangsu (CN)

(21) Appl. No.: 14/360,729

(22) PCT Filed: Nov. 23, 2012
(86) PCT No.: PCT/EP2012/073460

§ 371 Date: May 27, 2014

Related U.S. Application Data
(63) Continuation of application No. PCT/CN2011/083051, filed on Nov. 28, 2011.

(51) Int. Cl. B66B 7/06; B29C 47/02; B29C 47/08

(52) U.S. Cl. CPC B66B 7/06; B29C 47/08; B29C 47/025; B29C 2793/0027; B29C 2793/009; B29L 2009/003
USPC 427/289; 118/419; 428/683; 428/677; 428/680; 428/663

(57) ABSTRACT

A steel cord (2) for an extrusion process, where a steel wire (6) is connected to the leading end of the steel cord (2). The steel wire (6) is easy to insert through an extruder head (12) and leads the steel cord (2) through the extruder head (12), to facilitate the change-over of steel cord (12) on an extruder (10) to reduce the change-over time. Also an apparatus (10), a change-over process, and the use of the steel cord (2) for an extrusion process is disclosed.

### TECHNICAL FIELD

The invention relates to a steel cord for extrusion process, and in particular to a steel cord where a steel wire is connected to the leading end of the steel cord. This invention also provides an apparatus, a change-over process, and the use of steel cord incorporating present invention.

### BACKGROUND ART

Elevator rope as disclosed in WO2004/076327A1, and cable as disclosed in WO03/044267A1 are widely used, wherein a steel cord is coated with a polymer material through extrusion process, as disclosed in BE1006346. In the extrusion process, the change over time for re-load new steel cord is too long, because new steel cord cannot go through the extruder head when the extruder head is full of polymer, while the polymer will burn inside the extruder head when the heating is not turn off during change over. Therefore, the change-over may comprise following step: stop the extruder, turn off the heating, cool the extruder head, remove the extruder head, open the extruder head and remove the remaining polymer inside, reload the extruder head, insert new steel cord through the extruder head, turn on the heating, start the extruder, fine tune the process parameter to resume production. Since there may be 2 to 140 and more steel cords for the extrusion process, the change-over of steel cord on an extruder is long. In a typical application, where 12 steel cords are to be coated with polymer simultaneously, the change-over time is around 8 hours because the extruder head needs to be re-heated to about 500° C. in an oven to remove the PU remained inside. Therefore, industry is looking for solutions to cut the change-over time and boost the productivity.

### DISCLOSURE OF INVENTION

The primary object of the invention is to provide a steel cord to facilitate the change-over of extrusion process. It is also the objective of present invention to provide the use of the steel cord for abovementioned extrusion process.

According a first aspect of the invention a product is claimed that a steel cord is characterized in that a steel wire is connected to the leading end of said steel cord, wherein the leading end means the end of steel cord which is on the surface of steel cord spool.

The inventive product relates to the combination of features as described in claim 1. Specific features for preferred embodiments of the invention are set on in the dependent claims.

According to present invention, the steel wire is welded to the leading end of said steel cord. Besides, other ways of connection can be brazing, soldering, and gluing.

According to present invention, the diameter of the steel wire is not greater than the diameter of the steel cord. Preferably the diameter of the steel wire is between 60% to 100% of the diameter of the steel cord, and more preferably the diameter of the steel wire is between 90% to 98% of the diameter of the steel cord.

According to present invention, the surface of the steel wire is harder than zinc, and preferably the steel wire is either a stainless steel wire or a steel wire coated with a coating harder than zinc, wherein the coating can be a copper coating, a brass-coating, a nickel coating, or a chromium coating.

According to present invention, the leading end of the steel wire is chamfered or rounded to facilitate the insertion of steel wire through the extruder head.

According a second aspect of the invention an apparatus is claimed that an assembly of steel cord according to claim 1 and an extruder having an extruder head, wherein the length of the steel wire is greater than the length of extruder head.

According a third aspect of the invention a process is claimed that a process for change steel cord on an extruder is characterized by following steps:

a. stop the extruder and remove remaining steel cords

b. insert the steel wire of the steel cord according to claim 1 through the extruder head;

c. pull the steel wire and lead the steel cord through the extruder head;

d. cut off the steel wire;

e. start the extruder and resume production.

According a fourth aspect of the invention a method is claimed that the use of a steel cord as claimed in claim 1 for extrusion process.

### BRIEF DESCRIPTION OF FIGURES IN THE DRAWINGS

FIG. 1 describes a first preferred embodiment of the invention.

FIG. 2 describes a magnified view of first preferred embodiment.

FIG. 3 describes an apparatus of the invention.

### MODE(S) FOR CARRYING OUT THE INVENTION

Preferred embodiments of the present invention will be described herein below with reference to the accompanying figures.

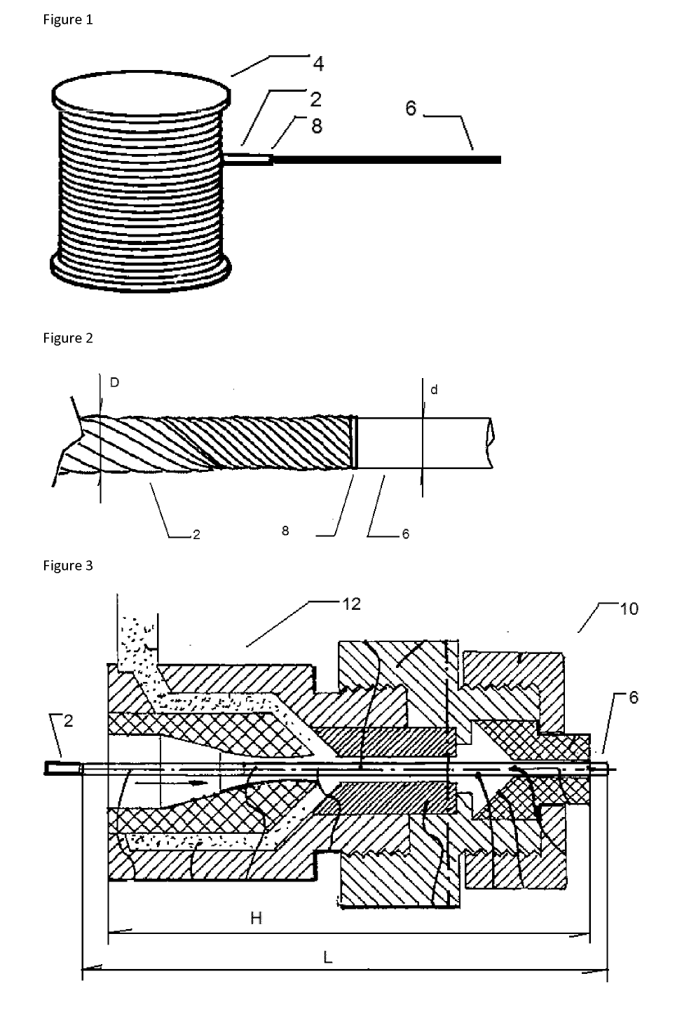

A first embodiment is illustrated in FIG. 1, wherein a steel cord 2 is wound on a steel cord spool 4, and a steel wire 6 is connected to the leading end 8 of the steel cord 2.

The steel wire 6 can be welded to the leading end 8 of the steel cord 2 as disclosed in WO2003/100164A1, while other ways of connection can be brazing, soldering, and gluing as disclosed in WO2004/007833A1. Since leading steel cord through extruder head may needs a few hundred newton, welding and other ways of connections will do. Compared with other ways of connection, welding is a very good option, because in the extrusion process the connection will go through the extruder head which is heated at a temperature as high as 230° C. and the connection between the steel cord and steel wire can be maintained.

FIG. 2 illustrates a magnified view of the connection between steel cord 2 and steel wire 6, wherein D is the diameter of the steel cord 2 and d the diameter of the steel wire 6. The diameter of the steel wire 6 is not greater than the diameter of the steel cord 2, because in the extrusion process the gap between the steel cord and the inner surface of the extruder head is usually about 0.05 mm to 0.5 mm, and it is better to have a leading wire with smaller diameter to guide the steel cord through the extruder head. The diameter of the steel wire is preferred between 60% to 100%, and more preferred between 90% to 98%, of the diameter of the steel cord, because we need more area between the steel cord 2 and steel wire 6 to maintain a strong connection.

A mechanical test on a specimen shows following data

| Steel cord diameter | 1.61 mm |
|---|---|
| Steel wire diameter | 1.56 mm |
| Steel wire diameter/steel cord diameter | 97% |
| Steel cord break load | 3000 N |
| Weld connection break load | 1311 N |
| Weld connection break load/steel cord break load | 44% |

While the According to present invention, the surface of the steel wire is harder than zinc, and preferably the steel wire is either a stainless steel wire or a steel wire coated with a coating harder than zinc, wherein the coating can be a copper coating, a brass-coating, a nickel coating, or a chromium coating.

Firstly, the surface of the steel wire is harder than zinc, because the steel wire is to be inserted through the extruder head and the hard surface of the steel wire is to guarantee that the steel wire is not to be cut and jam inside the extruder head. Secondly, a stainless steel wire is a good option, because not only stainless steel wire itself is strong enough but also the surface of stainless steel wire is hard enough to go through the extruder head. Thirdly, a steel wire coated with a coating harder than zinc, for example, a copper coating, a brass-coating, a nickel coating, or a chromium coating, is also a good option, because not only steel wire itself is strong enough but also the surface of the coated steel wire is hard enough to go through the extruder head.

According to present invention, the leading end of the steel wire is chamfered or rounded to facilitate the insertion of steel wire through the extruder head.

l FIG. 3 illustrates an apparatus 10 of present invention, wherein steel wire 6, connected to the leading end of steel cord 2, is inserted through an extruder head 12. L the length of the steel wire 6 is greater than H the length of the extruder head 12, because steel wire should be longer than the extruder head to insert through.

The process for change steel cord incorporating present invention on an extruder is characterized by following steps:

a. stop the extruder and remove remaining steel cords;

b. insert the steel wire of the steel cord according to claim 1 through the extruder head;

c. pull the steel wire and lead the steel cord through the extruder head;

d. cut off the steel wire;

e. start the extruder and resume production.

Since the steel wire is strong and can be easily inserted through the extruder head, it is not necessary to stop the heating of the extruder, because the changeover of steel cord can be done in a minute.

The use of the steel cord incorporating present invention for extrusion process.

1.-13. (canceled)

14. A steel cord, characterized in that a steel wire is connected to the leading end of said steel cord.

15. A steel cord according to claim 14, wherein the steel wire is welded to the leading end of said steel cord.

16. A steel cord according to claim 14, wherein the diameter of the steel wire is not greater than the diameter of the steel cord.

17. A steel cord according to claim 16, wherein the diameter of the steel wire is between 60% to 100% of the diameter of the steel cord.

18. A steel cord according to claim 17, wherein the diameter of the steel wire is between 90% to 98% of the diameter of the steel cord.

19. A steel cord according to claim 14, wherein the surface of the steel wire is harder than zinc.

20. A steel cord according to claim 19, wherein the steel wire is a stainless steel wire.

21. A steel cord according to claim 19, wherein the steel wire is coated with a coating harder than zinc.

22. A steel cord according to claim 21, wherein the coating is a copper coating, a brass-coating, a nickel coating, or a chromium coating.

23. A steel cord according to claim 14, wherein the leading end of the steel wire is chamfered or rounded.

24. Use of a steel cord according to claim 14 for extrusion process.

25. An assembly of a steel cord according to claim 14 and an extruder, said extruder having an extruder head, wherein the length of the steel wire is greater than the length of extruder head.

26. A process of change steel cord on an extruder, characterized by following steps:
a. stop the extruder and remove remaining steel cords;
b. insert the steel wire of the steel cord according to claim 14 through the extruder head;
c. pull the steel wire and lead the steel cord through the extruder head;
d. cut off the steel wire;
e. start the extruder and resume production.
